(19) United States
(12) Patent Application Publication
(10) Pub. No.: US 2020/0076064 A1
(43) Pub. Date: Mar. 5, 2020

(54) SYSTEM, METHOD AND COMPUTER-ACCESSIBLE MEDIUM FOR COMPLIANCE ASSESSMENT AND ACTIVE POWER MANAGEMENT FOR SAFE USE OF RADIOWAVE EMITTING DEVICES

(71) Applicant: NEW YORK UNIVERSITY, New York, NY (US)

(72) Inventors: Leeor ALON, New York, NY (US); Cem Murat Deniz, Long Island City, NY (US); Christopher M. Collins, Elizabethtown, PA (US); Daniel K. Sodickson, Larchmont, NY (US)

(21) Appl. No.: 16/678,507

(22) Filed: Nov. 8, 2019

Related U.S. Application Data
(63) Continuation of application No. 15/522,804, filed on Apr. 28, 2017.
(60) Provisional application No. 62/069,709, filed on Oct. 28, 2014.

(51) Int. Cl. H01Q 1/24; H04B 1/3827; H01Q 21/06; H01Q 3/40; H01Q 3/28; H01Q 3/26; H04B 17/10

(52) U.S. Cl. CPC H01Q 1/245; H04B 1/3838; H01Q 21/065; H04B 17/102; H01Q 3/28; H01Q 3/267; H01Q 3/40

(57) ABSTRACT

An exemplary system, method and computer-accessible medium for determining an effect of a millimeter wave (mmWave) radiation on an object(s), can be provided, which can include, for example, receiving information associated with a thermal(s), E field or H field scan of at the object(s) based on the mmWave radiation, and determining the effect of the mmWave radiation(s) based on the information. The information can be determined using a bioheat equation, which can be a Pennes' bioheat equation. The information can include a specific absorption rate of the mmWave radiation and/or a temperature change across the at least one object. The object(s) can be a live subject(s).

### CROSS-REFERENCE TO RELATED APPLICATION(S)

This application relates to and claims priority from U.S. Patent Application Ser. No. 62/069,709, filed on Oct. 28,2014, the entire disclosure of which is incorporated herein by reference.

### FIELD OF THE DISCLOSURE

The present disclosure relates generally the safety assessment of radiowave emitting devices, and more specifically, to exemplary embodiments of an exemplary system, method and computer-accessible medium for the compliance assessment and active power management of radio wave emitting devices.

### BACKGROUND INFORMATION

Recently, millimeter wave (e.g., mmWave) technology has been gaining significant interest for wireless communications. Devices and antennas operating at the millimeter wave frequencies have a reduced size compared to previous radio frequency (“RF”)/microwave technologies, and it has been demonstrated that high transfer rates can be possible using millimeter wave communication, making the technology highly desirable for public use. In order to protect the public from adverse health effects, mmWave devices may need to undergo careful evaluation such that they comply with government exposure standards before being introduced into the market. At microwave frequencies, the specific absorption rate (“SAR”), the rate of energy absorption in biological tissue, can be measured and used to limit exposure. However, at mmWave frequencies, energy absorption can be confined to the surface of the tissues since the penetration depth of these waves can be short. As result, heating can mostly occur at the surface. Since most of the energy deposited by mmWave communications can be absorbed on the surface of the human body, the primary organs of concern can be the eyes and skin. Some studies have investigated changes that occur in the eyes, since they can be a region with a high conductivity and a low perfusion rate. These studies have shown that ocular lesions have been found after exposure of about 10 mW/cm² for about 6 minutes, while other studies focusing on about 60 GHz frequencies showed no detectable physical modification was present at these power levels.

The small wavelengths of mmWave signals alongside advances in radio frequency (“RF”) circuitry can enable a large number of miniaturized antennas to be placed in small dimensions. These exemplary multiple antenna systems can be used to form very high gain electrically steerable antennas. These electrically steerable antennas can be placed in many communication devices, such as base stations, routers, cell phones etc. These exemplary antenna arrays can enable the changing of the direction of the main lobe of radiation pattern by beam steering. Beam steering can be accomplished by changing the relative amplitude and phase of the RF signals driving the antenna elements, or by mechanically moving the antenna elements such that aimed propagation pattern is achieved. (See, e.g., FIG. 1).

### Exemplary Challenges Associated With mmWave Power Deposition Quantification

Since the penetration depth of mmWave can be on the order of millimeters, current electric (“E”) field probe systems have probes that may not be capable of accurately probing the E field on the surface of materials since these probes can lose their accuracy due to the tissue-air boundary interactions and a loss of measurement isotropy. As a result, compliance agencies utilize external antennas used to measure the power density emitting by mmWave antenna. Typically, the antenna can be placed at least about 2 wavelengths away from the source in the far field, and then the E or H field strength can be measured. Using Eq. 1 below, the power density (“PD”) can then be calculated. While PD can measure the energy absorbed by the device, a large portion of the energy can be reflected by the dielectric medium, which can often lead to over estimation of the energy absorbed inside the tissue. As result, PD measurements often significantly restrict (i) the energy deposited inside tissue and (ii) possible thermal damage induced by mmWave devices. While PD measurements have been shown to be conservative, several studies have shown that they tend to be over conservative, and operation at PD limits of about 10 mW/cm² can induce a temperature change of around 0.1 degree C. This temperature change can be very restrictive, and thermal damage may not be possible at these levels. Conversely, reliance on temperature change rather than PD can (i) enable utilization of wireless devices with higher output power, (ii) reduce cost to the manufacturers and (iii) improve quality of communication between mmWave devices, all while ensuring safe utilization of mmWave devices.

Another challenge associate with mmWave power deposition quantification can be related to the use of phased antenna arrays. Phase antenna arrays have great flexibility in steering the main lobe of the transmit/receive profile to improve communication. This flexibility has been a motivating factor for enabling very flexible communication patterns. However, changing of the phase and amplitude of the antenna elements in a phased array can also change the energy deposition pattern inside the body. As a result, improved methods of quantification of the energy inside phantoms or fee body need to be developed.

Furthermore, since mmWaves can be confined to the surface of the tissue, the waves cannot be measured on the surface of tissues using conventional SAR measurement systems that use an articulated robot and probe the E field inside a tissue mimicking liquid phantom. Due to these constraints, regulatory committees, including the Federal Communications Commission (“FCC”) and International Commission on Non-Ionizing Radiation Protection (“ICNIRP”), have issued guidelines feat utilize incident power density as a metric to limit exposure. Power density can be defined as the magnitude of the power density of a plane wave having the same E or magnetic (“H”) field strength. Equivalent plane-wave power density can be defined as, for example:

$$\text{?} = \text{?} = \text{?} {\vert H \vert}^{2} \\ \text{?} \text{indicates text missing or illegible when filed} \qquad ( 1 )$$

where E and H can be the root mean square (“RMS”) values of the electric and magnetic fields strength, respectively, and η can be the wave impedance (e.g., 377 ohms in free space). According to the FCC, for far field exposures, the power density should not exceed about 10 W/m² (1 mW/cm²) for the general public and about 50 W/m² for occupational groups. Furthermore, the spatial maximum PD averaged over about 1 cm2 average should not exceed about 20 times the PD averaged over about 20 cm².

Thus, it may be beneficial to provide an exemplary system, method and computer-accessible medium for compliance assessment and active power management for safe use of radio wave emitting devices, which can overcome at least some of the deficiencies described herein above.

### SUMMARY OF EXEMPLARY EMBODIMENTS

An exemplary system, method and computer-accessible medium for determining an effect of a millimeter wave (“mmWave”) radiation on an objects), can be provided, which can include, for example, receiving information associated with a thermal scan of the object(s), or an E or H field measurements from an individual or a series of probe(s) based on the mmWave radiation, and determining the effect of the mmWave radiation based on the information. The information can be determined using a bioheat equation, which can be a Pennes' bioheat equation. The information can include a specific absorption rate of the mmWave radiation and/or a temperature change across the at least one object. The object(s) can be a live subjects).

In certain exemplary embodiments of the present disclosure, the information can be generated based on an array arrangement that receives the mmWave radiation. The array arrangement can be a two-dimensional array arrangement that can be configured to measure a magnitude of an electric field or a magnetic field caused by the mmWave radiation. The array arrangement can include a plurality of electro-optical (EO) probes, E field probes, H field probes, thermal probes and more which can be positioned (i) in three orthogonal axes or (ii) in a two dimensional plane or (iii) in a vector. The probes can also be positioned in 3D space around that phantom.

A further exemplary embodiment of the present disclosure can include a system, method and computer-accessible medium for causing a change in a direction of an antenna(s) in a millimeter wave (“mmWave”) portable electronic device(s), which can include, for example, receiving information related to a power deposition of the mmWave portable electronic device(s) in a live subject(s) or in a phantom used for compliance purposes, and causing the change in the direction based on the information.

In certain exemplary embodiments of the present disclosure, the portable electronic device can be a cell phone. The information car be determined based on a forward power(s) emanating from the mmWave portable electronic device(s) and a reflective power(s) received by the mmWave portable electronic device antenna(s). The direction of the beam can be selected based on a location and power of a base station(s) configured to wirelessly connect to the mmWave portable electronic device(s). A change in the direction can be caused based on an electric field correlation matrix(es) related to a power deposition of the mmWave portable electronic device(s). In some exemplary embodiments of the present disclosure, the change in the EM radiation direction can be caused by adjusting an amplitude and a phase of an antenna array.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is a diagram of an exemplary antenna element according to an exemplary embodiment of the present disclosure;

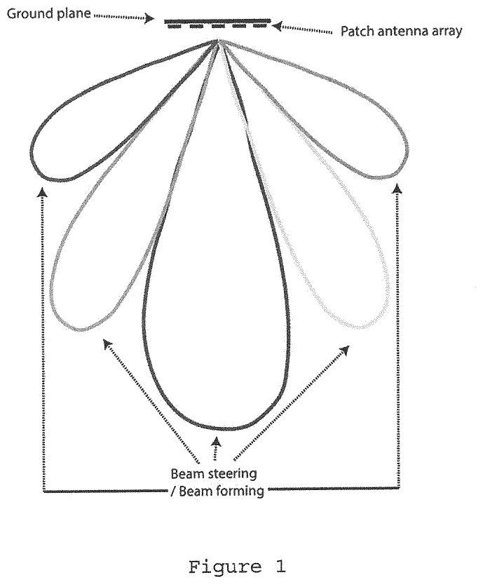

FIG. 2 is a portable electronic device and an EO probe according to an exemplary embodiment of the present disclosure;

FIG. 3 is a graph of n-channel pulses according to an exemplary embodiment of the present disclosure;

FIG. 4 is a diagram of an exemplary antenna arrangement according to an exemplary embodiment of the present disclosure;

FIG. 5 is a diagram of an exemplary location of various antennas in mobile device relative to the head of a person and the associated |Q| chart according to an exemplary embodiment of the present disclosure;

FIG. 6 is a flow diagram of an exemplary method for determining an effect of a millimeter wave (mmWave) radiation on at least one object according to an exemplary embodiment of the present disclosure;

FIG. 7 is a flow diagram of an exemplary method for causing a change in a direction of an antenna of a portable electronic device according to an exemplary embodiment of the present disclosure; and

FIG. 8 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

### Exemplary mmWave Communication and Antennas

The exemplary system, method and computer-accessible medium, according to an exemplary embodiment of the present disclosure, can be used for, for example, (i) temperature or E or H field measurement based safety estimation for mmWave devices with phased arrays, (ii) estimation of the maximum local energy deposition induced by phased arrays, (iii) a Global power deposition measurement system implementable in mm Wave devices, which can also be usable as a proximity sensor, and (iv) a procedure for improved communication alongside a reduction of the power deposition in subjects using mmWave devices with phased arrays.

### Exemplary Estimation of Maximum Local Energy Deposition Using E Field Probes or H Field Probes Alongside Inverse Maxwell Equations Methods or Thermal Mapping Procedures

The hallmark of compliance measurement of mmWave devices can be their short wavelength and penetration depth alongside the use of a large number of transmit antenna elements complicating the estimation of the maximum SAR estimation inside the body. In order to properly estimate the maximum power deposition in phantoms, E field or H field probes can be used. These probes can sense the E or H field probe with minimal interference between the device under testing (“DUT”) and the probes. The size of the probes should be sufficiently small such that it is able to probe the E or H field close to the surface of the air-phantom boundary where a significant power deposition from mmWaves can occur.

### Exemplary Measurement Systems For Use Of mmWave Device Compliance

Exemplary Single E Field Probe Systems: Standardized compliance testing below about 6 GHz can utilize a single E field probe that can be mechanically moved using an articulated robotic arm in a point-by-point, grid-like fashion, in 3D space inside a phantom filled with a liquid mimicking the electrical properties of human tissues. E field probes can be designed and calibrated to be isotropic. For standard tests, E field can typically be probed first using a fast scan, which can search for the maximum E field on a 2D plane with coarse resolution. After the maximum E field on the 2D plane can be identified, a fine-resolution 3D scan can be conducted, and 1 or 10 g average SAR can be computed from the magnitude E field measurements.

Exemplary Array E Field Probe Systems: These exemplary systems and methods can be used to provide an estimation of the power deposition in the order of few seconds. These exemplary E field array systems and methods can utilize a large number of highly dense arrays placed on a 2D plane located inside a solid phantom. When the DUT is activated next to the phantom, the magnitude of the E field can be measured on that plane, and 3D extrapolation procedures can be used to assess the SAR between the measurement plane and the surface of the phantom.

Exemplary Electro Optical Probe Systems: Electro-optical (“EO”) probes have been developed using various strategies, using miniature dipole antennas and bulk crystals, such as LiNBO3 and CdTe, by measuring either the E field or the H field. The exemplary EO probes can rely on the electro-optic effect and car play an important role in optoelectronics, as it can facilitate the modulation of optical beams by electric signals. Similar to the E field probes, EO crystals can be located in three orthogonal axes to measure orthogonal components of the E fields, simultaneously.

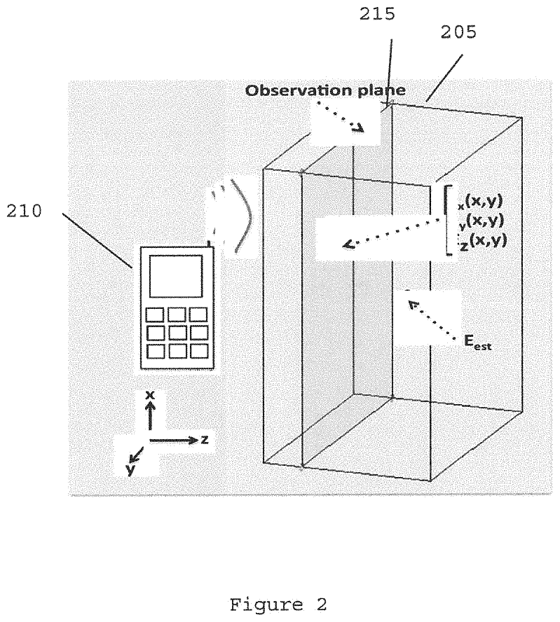

Exemplary Vector Array EO Probe System: 3- or 2-dimensional arrays of EO probes (e.g., element 205 of FIG. 2) that can typically be placed several millimeters inside dielectric phantoms near a portable electronic device 210. Vector probes can be capable of measuring both the magnitude and phase of EM field, and several vector systems have been designed between the DC to 6 GHz range. For compliance measurement EO probes can typically be oriented as part of an “observation plane” 215 where a large number of highly densely populated probes can be distributed in a single 2-dimensional plane. (See e.g., FIG. 2). Field information can then be collected using the vector probe array and the 3D SAR distribution inside the phantom can be estimated close to the DUT. In order to enable the calculation of the 3D SAR distribution properly, vector array systems rely on the equivalence principle and image theory. These can assume that (i) EM waves may only be incident through the “observation plane” (ii) no reflections can occur within the phantom, and (iii) The electric and magnetic fields at the observation plane can be assumed to be secondary sources. Via these assumptions, the E field distributions at different depths can be estimated, and subsequently spatially average SAR can be computed from these calculations.

Exemplary Fiber Optical Thermal Sensors: Temperature-based dosimetry systems have been developed using a 3D array of optical fiber thermal sensors positioned inside a tissue mimicking a semisolid phantom. The average SAR can be evaluated within a 1- or 10-g mass covered by multiple optical fiber thermal sensors by measuring the temperature rise ΔT due to microwave exposure in each sensor location, and using SAR=CₚₕΔT/Δt, where Cₚₕ can be the specific heat of the semisolid phantom material and Δt can be the exposure duration. Thermal SAR evaluation systems illustrated agreement with E field probe measurements for frequencies <about 6 GHz. Additionally, such exemplary systems and/or measurements can be used for validating the standard based on E field probes.

Exemplary Thermal Magnetic Resonance Scanner Systems: Thermal scanning using magnetic resonance imaging (“MRI”) has been used to non-invasively quantify temperature and energy deposition induced by MRI coils in the MHz frequency range. Recently, the procedure has been expanded to accommodate high frequency wireless devices that have traditionally been considered incompatible with MRI. The exemplary method can be sensitive to small temperature changes (e.g., <about 0.1° C.), and can evaluate SAR with millimeter resolution. Compared to other temperature-based methods, SAR can be evaluated by directly inverting the heat equation using physical measurements acquired using magnetic resonance (“MR”) (e.g., high-resolution temperature) and thermal property probes (e.g., heat capacity and thermal conductivity). The utilization of the heat equation inversion can mitigate errors associated with heat diffusion and energy exchange with air, and can remove the requirement of changing device exposure characteristics to shorten the heating duration.

Exemplary Optical SAR Systems: True SAR measurements of RF radiation can also be detected through the deflection of laser beams that can be produced by the RF energy absorbed in a transparent phantom. Using multiple diode lasers, the exemplary system can detect the temperature change in a phantom (e.g., filled with tissue simulating liquid) along several paths and can convert it into SAR using the specific heat of the phantom and the duration of the exposure.

Infrared (“IR”) thermometry can commonly be used to map temperature changes on the surface of objects, however, here information provided by IR can be used to estimate the power deposition from mmWave devices. IR measurement systems can detect thermal radiation on surfaces of objects. IR systems can measure the thermal energy that radiates off surfaces, and can convert it to electrical signals, which can then be converted into temperature measurements. IR measurement systems take into account the ambient temperature and other factors (e.g., the material of the surface) to produce a reliable, accurate, measurement. Different IR measurement systems can measure either at a spot on the surface (e.g., an IR gun) or measure over many points of a large area (e.g., IR cameras). Overall, IR systems can be effective for measuring the radiation from RF emissions. When using IR, the temperature change on the surface of semi-solid phantoms can be measured post exposure to the RF waves, since the temperature on the surface can be known, it can be possible to estimate the energy exchange between the phantom and air account for the energy loss to air due to the boundary conditions associated with the heal equation. Once known, the power deposition can be estimated.

### Exemplary Magnitude Only Measurements Versus Magnitude And Phase Measurements

Because the exemplary devices described herein can operate in the near field, a large number of tests will have to take place in order to properly characterize the power deposition from these devices and this can amount to a significant time spent for compliance testing of these devices, especially if large number of antenna elements can be present in the device. Therefore, an exemplary knowledge of both amplitude and phase (e.g., in three dimensions) of the fields generated can reduce the time needed for compliance testing. For example, a transmit array antenna can have N-antennas, e.g., if the phase and amplitude information can be known, and N number measurements per mode and position can be utilized. While conversely, N² measurements can be needed (e.g., the exemplary procedures detailed above) when the magnitude alone can be known. Depending on the size of the antenna array, and the spacing between antenna elements, several assumptions can be made in order to reduce the testing time utilized.

With respect to non-invasive methodologies, thermal mapping using MRI has been shown to be capable of characterization of the power deposition from mmWave devices. This exemplary method can be desirable for measuring the temperature change at a much higher resolution than shown previously, which has been demonstrated useful for probing close to surfaces boundaries. One clear advantage that temperature measurement holds can be its frequency insensitivity. This means that simultaneous transmission can take place while measuring the end result (e.g., temperature change).

EO probe systems can be or include wide band, small and since most of the signal can be transmitted via optical cabling, there can be smaller interference between the EO probe and the DUT, relative to other invasive probe systems, since no conductive materials can be used. As a result, probing of close to phantom-air boundaries without disrupting the E field can be expected. EO probe systems can also be capable of measuring the peak E field from several different frequencies at once, which can facilitate the simultaneous measurement of the power deposited from several transmitting modalities at once. This can be particularly useful since DUT often can transmit simultaneously at different frequencies, and it can be useful to know the E field generated from each of the bands. This ability to measure several frequencies at once can further improve the speed of testing for mmWave devices. Furthermore, since EO probe systems can be capable of measuring the amplitude and phase of the E field, further reduction in test time can be expected when using these probes for mArr systems.

### Exemplary Probe Orientation In 2D/3D Space

E- or H- field probes often used for compliance purposes below 6 GHz can be tri-axis, meaning they can sense E or H field in all 3 axes. However, these probes can be larger in dimension than those utilized for mmWave assessment. In addition, when these exemplary probes can be arranged as part of an array system, cross talk between these probes can be possible in addition to cross talk between the DUT and the probes. Therefore, the exemplary system, method and computer-accessible medium, according to an exemplary embodiment of the present disclosure, can reduce the density of the tri-axis probes. Conventionally, tri-axis probes can be placed in a 2D array inside the phantom. However, for mmWave compliance, and probe density reduction, directional probes can be interspersed inside the phantom. For example in ID, instead of having 9 tri-axis probes placed adjacent to one another, directional probes can be placed in the following series along the one dimensional line: Ex, Ey Ez, Ex, Ey, Ez, Ex Ey, Ez. Then, since the Ex, Ey and Ez fields inside the phantom can be smoothly varying, the complete fields can be independently calculated, for example using interpolation in space (e.g., amplitude/phase). These can be used to estimate the local power deposition with an acceptable error margin.

### Exemplary Power Deposition Measurement System Implementable For mmWave Devices From Magnitude Measurements

In mmWave communications, beam steering can be performed by an adjustment of the amplitudes and phases of antenna arrays. Consider a network perspective of mmWave transmit case where the subject and antenna structure can be viewed as a multi-port network that can interact with multiple sources through the ports. A linear system relationship between the electromagnetic fields and the source configuration can imply that the net E field can be expressed as a weighted superposition of E fields associated with the N antennas employed for wireless transmission. Local RF power deposition, which can be caused by Joule heating and polarization damping forces, can be proportional to the square of local net E field strength: ξ_{local}=1/2σ|E|², where σ can be the tissue conductivity. Over a Δt time interval, during RF transmit local as well as overall RF power dissipation in the N-port network, can be expressed as quadratic functions in v⁽¹⁾, v⁽²⁾, . . . and v^{(N)}, where, for example:

global energy power deposition ξ=v^{H}Q v, (2)

where Q can be a N-by-N positive definite Hermitian matrix, and v=[v⁽¹⁾ . . . v^{(N)}]^{T} can be a vector collecting the magnitude-phase pairs defining the N mmWave pulses for the Δt time interval.

Q can be estimated experimentally using power sensor data collected at the ports. By the law of conservation of energy, Σp_{fwd}−Σp_{rlf}, the net mmWave power injected into the N-port network can be equal to ξ, and the overall power dissipation in the network which can equal the forward minus reflective power measurements. Given v_{q}, a source configuration for the qth time interval, Σp_{fwd}−Σp_{rlf}, as computed from the sensor readings, can be related to v_{q} by, for example:

Σp_{fwd,q}−Σp_{rfl,q}=v_{q}^{H}Q v_{q}=Σᵢⱼ conv(v_{q}⁽ⁱ⁾)v_{q}⁽ⁱ⁾Qᵢⱼ , (3)

Eq. 3 can be a linear equation with Qᵢⱼ, the entries of Q, as the unknowns, and product terms, conj(v_{q}⁽ⁱ⁾) v_{q}⁽ⁱ⁾, as the coefficients. Carrying out calibration experiments with N², or more property prescribed source configurations played out one at a time, can probe the mmWave loss characteristic of the multi-port network, facilitating Eq. 4-type equations to be assembled, and ail the entries of Q to be determined by way of a least squares solution which can be very robust against perturbation/noise. Once the calibration can be done, the mmWave power prediction model can enable the prediction of the power deposition for any arbitrary source configuration or mmWave transmit pulses for beamsteering. The exemplary system, method and computer-accessible medium, according to an exemplary embodiment of the present disclosure can also predict individual channel forward or reflected power for each element of the mmWave antenna array. In this case, Eq. 3 can be modified to assume the form of, for example:

nth channel p_{fwd,q}=v_{q}^{H}Q_{fwd(n)}v_{q} , (4)

or

nth channel p_{rfl,q}=v_{q}^{H}Q_{rfl(n)}v_{q} , (5)

Through the calibration experiments, the nth mmWave transmit channel's forward and reflected power transmission can be fully characterized. Their predicted values for an arbitrary source configuration v can be, v^{H} Q_{fwd(n)} v and v^{H} Q_{rlf(n)} v.

While Eq. 3, depicts a case in which the global power deposition can be characterized and predicted, a similar model can be applicable for local power deposition, where, for example:

local mmWave power deposition ξ(r)v^{H}Λ(r)v , (6)

where ξ(r) can be the total local energy deposition in position r, and Λ(r) can be defined as the local electric field correlation matrix at position r. Calibration of the local power deposition can be performed using thermal measurements acquired using temperature measurements that can be capable of tracking the thermal change induced by mmWaves as governed by the Pennes' heat equation, and inverting the temperature measurements to average SAR. Temperature measurements can be acquired using several modalities that can be sensitive enough to detect temperature change accurately, such as Magnetic Resonance Thermometry (“MRT”) or Infrared Thermometry (“IRT”). Infrared thermometry can be particularly useful for high frequency mmWave devices, since a large portion of the energy can be deposited on the surface of the body. Additionally, an exemplary calibration of the local power deposition can be performed using E or H field measurements while playing out N², or more properly prescribed source configurations one at a time. These exemplary measurements can be performed on a phantom for compliance measurements using single probe or probe array systems capable of measuring E or H field information.

### Exemplary Reduction of Testing Time For Maximum Local Energy Deposition Induced By Phased Arrays

For prediction of global and local power deposition, N² measurements can be utilized, where N can be the number of transmit elements used in the device. Since many calibration steps can often be used for such devices, it can be desirable to reduce the number of steps used to predict local or global power deposition at the expense of providing an upper bound for those quantities. The exemplary system, method and computer-accessible medium, according to an exemplary embodiment of the present disclosure, can utilize an upper bound to the power deposition while reducing test time.

The electric field generated by the k-th antenna can be written in phasor notation as Eₖ=|Eₖ(r)|exp(iθₖ(r)). Local SAR generated by E fields from n-antennas, can be expressed as. for example:

$$SAR ( r ) = \text{?} {\vert {E}_{total} \vert}^{2} \\ \text{?} \text{indicates text missing or illegible when filed} \qquad ( 7 )$$

In the case of a 2-antenna experiment, local SAR can be bound by assuming constructive interference, where, for example:

$$SAR ( r ) = \text{?} {\vert {E}_{1} ( r ) + {E}_{2} ( r ) + … + {E}_{n} ( r ) \vert}^{2} \leq \text{?} {( \vert {E}_{1} ( r ) \vert + \vert {E}_{2} ( r ) \vert + … + E {\vert}_{n} ( r ) \vert )}^{2} \\ \text{?} \text{indicates text missing or illegible when filed} \qquad ( 8 )$$

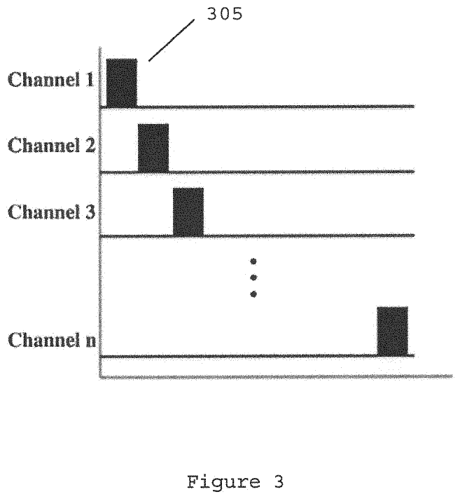

Since measuring the magnitude of the E field interference pattern Λ(r) can utilize N² measurements, it can be possible to bound the maximum E field interference pattern from a N-transmit element array using a single measurement. For example, assume two antennas transmitting at non-overlapping times, in each exemplary time period (e.g., time period 305 of FIG. 3) of the exemplary experiment, as shown in FIG. 3, which illustrates a N-channel pulse played out with no temporal overlapping.

In the exemplary case of the non-overlapping pulse, local SAR can be expressed as, for example:

$$SAR ( r ) = \text{?} ( {\vert {E}_{1} ( r ) \vert}^{2} + {\vert {E}_{1} ( r ) \vert}^{2} + … + {\vert {E}_{n} ( r ) \vert}^{2} ) \\ \text{?} \text{indicates text missing or illegible when filed} \qquad ( 9 )$$

Further the inequality of arithmetic and geometric means can be stated as follows:

$$\text{?} \geq {( {E}_{1} {E}_{2} - {E}_{n} )}^{1 / n} \\ \text{?} \text{indicates text missing or illegible when filed} \qquad ( 10 )$$

For an n=2 case,

$$\text{?} \geq {E}_{1} {E}_{l} . \\ \text{?} \text{indicates text missing or illegible when filed}$$

Applying the inequality of arithmetic and geometric means into Eq. 2 can yield the following exemplary inequality for an n-antenna case:

$$\text{?} ( {\vert {E}_{1} ( r ) \vert}^{2} + {\vert {E}_{1} ( r ) \vert}^{2} + … + {\vert {E}_{n} ( r ) \vert}^{2} ) \geq \text{?} {( \vert {E}_{1} ( r ) \vert + \vert {E}_{2} ( r ) \vert + … + \vert {E}_{n} ( r ) \vert )}^{2} \\ \text{?} \text{indicates text missing or illegible when filed} \qquad ( 11 )$$

where the left side of Eq. 11 can be measured using a single exemplary MR thermometry experiment or a single exemplary E or H field measurement experiments, which can provide an upper bound for local SAR, and a worst case estimate for a particular array-object setup. A 2-antenna example can be assumed in which the inequality of arithmetic and geometric means can be used to provide an upper bound for local SAR, which can yield the following:

$${( \vert {E}_{1} ( r ) \vert + \vert {E}_{2} ( r ) \vert )}^{2} = {\vert {E}_{1} ( r ) \vert}^{2} + {\vert {E}_{2} ( r ) \vert}^{2} + 2 \vert {E}_{1} ( r ) \vert \vert {E}_{2} ( r ) \vert \leq {\vert {E}_{1} ( r ) \vert}^{2} + {\vert {E}_{2} ( r ) \vert}^{2} + \frac{{( \vert {E}_{1} ( r ) \vert + \vert {E}_{2} ( r ) \vert )}^{2}}{2} \leq {\vert {E}_{1} ( r ) \vert}^{2} + {\vert {E}_{2} ( r ) \vert}^{2} + \frac{{\vert {E}_{1} ( r ) \vert}^{2}}{2} + \frac{{\vert {E}_{1} ( r ) \vert}^{2}}{2} + \vert {E}_{1} ( r ) \vert \vert {E}_{2} ( r ) \vert \leq {\vert {E}_{1} ( r ) \vert}^{2} + {\vert {E}_{2} ( r ) \vert}^{2} + \frac{{\vert {E}_{1} ( r ) \vert}^{2}}{2} + \frac{{\vert {E}_{1} ( r ) \vert}^{2}}{2} + \frac{{\vert {E}_{1} ( r ) \vert}^{2}}{4} + \frac{{\vert {E}_{1} ( r ) \vert}^{2}}{4} + \frac{\vert {E}_{1} ( r ) \vert \vert {E}_{2} ( r ) \vert}{2} \leq … \leq 2 ( {\vert {E}_{1} ( r ) \vert}^{2} + \vert {E}_{1} ( r ) \vert \text{?} )$$

$$\text{?} \text{indicates text missing or illegible when filed}$$

A similar expansion can be conducted for an N-antenna case.

### Exemplary Measurement Apparatus for Detecting Global Power Deposition For mmWaves

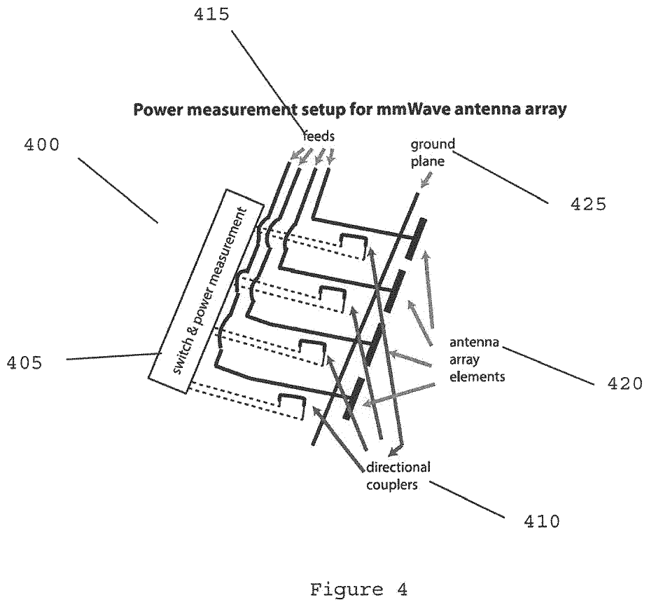

The exemplary system, method and computer-accessible medium, according to an exemplary embodiment of the present disclosure, can be used for the characterization and prediction of the global power deposition using the exemplary apparatus 400 illustrated in FIG. 4. For example, the forward and reflected power measurements 405 from each channel can be measured using a quarter wavelength, or other, directional coupler 410 positioned along the feed line 415 of the antenna or antenna array elements 420, which can be parallel to ground plane 425. The directional coupler 410 can be connected to a switch facilitating probing of the power in each channel. By using a calibration pulse with different amplitude and phase weightings, the global electric field correlation matrix, Q, can be calculated using an exemplary least square solution. The computation of the Q matrix can facilitate the prediction of the power deposition in the individual subject and device location next to the body. If an exemplary power deposition measurement can be significantly different from the predicted power, an extra calibration can be used. Significant difference between the calibration and prediction can represent a change in wave propagation properties of the exemplary antenna array.

Current mmWave devices utilize proximity sensors for beam steering of the mmWaves away of the body. These devices can utilize additional sensors positioned inside the device. Instead of using proximity sensors, the exemplary system, method and computer-accessible medium, according to an exemplary embodiment of the present disclosure, can obtain information regarding the position of the body using the global power deposition framework. Therefore, this exemplary embodiment can facilitate a detection of proximity of subject to the antenna array.

### Exemplary Procedure for Improved Communication Alongside Reduction of Power Deposition in Subjects Using mmWave Devices With Phased Arrays

Calibrated matrices Q and Λ from various types of measurements (e.g., power measurements, temperature-mapping measurements, electric field measurements, magnetic field measurements or any safety compliance relevant measurements) on a wireless device can be used to ensure safe operation of the wireless device. Initially the Q matrix can be calibrated in free air to characterize radiation losses (e.g., Q_{radiation}) due to the environment. Once Q_{radiation} can be characterized, it can be subtracted from the Q matrix calibrated during wireless device usage such that the power deposition in tissues can be estimated.

### Exemplary Maximum Efficiency Beamforming

The exemplary system, method and computer-accessible medium, according to an exemplary embodiment of the present disclosure, can use a calibrated power correlation matrix with real time power measurements from phased array antennas, and can select the best possible communication channels with lowest possible power deposition into the device user.

Beamforming can be provided to select communication channels by optimizing the relative amplitudes and phases of multiple transmit elements driven with a common waveform. Flexibility to control the relative amplitude and phase of the individual transmit elements can also be exploited to increase user safety or obey compliance. Below is a description of the exemplary maximum efficiency beamforming procedure, which can maximize communication links by proper channel selection for any given level of predefined power deposition into the user.

In order to obtain the complex-valued beamforming weights that correspond to the amplitude and phase modulation associated with maximum channel selection efficiency, a metric can be defined as downlink power correlations squared per unit-dissipated power in the user. Using the superposition principle of linear systems, the net signal (“S”) obtained from base stations and electric field E, at each spatial location r inside the user, and at each time t, can be defined as, for example:

s=Σₙ₌₁^{N}vⁿsⁿ and E(r)=Σₙ₌₁^{N}vⁿsⁿ(r) (12)

where N can be the number of transmit elements, and the weights vⁿ can specify the amplitude and phase modulation of the driving voltage or current waveform in the nth channel of an exemplary mmWave antenna array. The complex-valued sⁿ and sⁿ(r) can represent, respectively, the base station downlink signal and E fields that can correspond to unit weighting (e.g., or using a different reference value) on the nth channel and zero weights on other channels. The average signal power delivered to the base station (e.g., uplink) can be expressed as, for example:

average|s|²=v^{H}γv (13)

where the wireless device transmit power correlation matrix Γ can be obtained and updated from phone array power measurements, and H can denotes the conjugate transpose. Here, Γ can be an N×N positive-definite complex Hermitian matrix.

The total power deposited by the mmWave communication antenna arrays into the object at time t can be calculated by taking the following exemplary volume integral over the object, and substituting the linear superposition of the electric fields. Thus, for example:

$$P = \int \int \int \text{?} {‖ E ( r ) ‖}^{2} dr = \text{?} \\ \text{?} \text{indicates text missing or illegible when filed} \qquad ( 14 )$$

where σ can be the electrical conductivity, and Q as defined before the N×N positive-definite complex Hermitian power correlation matrix whose (i, j)-th element can be given by, for example:

$${Q}_{i , j} = \int \int \int \text{?} ( r ) \text{?} ( r ) dv \\ \text{?} \text{indicates text missing or illegible when filed} \qquad ( 15 )$$

and * can indicate complex conjugate.

Once Q can be calibrated, for example, from compliance measurements, power dissipation can be determined for any possible set of channel selection weights w, facilitating the prediction of the power deposition consequences of channel selection. Using the exemplary expressions for the average power from base stations, and the total RF power deposition for any channel selection weights w, the beamforming efficiency metric can be defined as, for example:

$$\text{?} = \text{?} \\ \text{?} \text{indicates text missing or illegible when filed} \qquad ( 16 )$$

By streamlining the downlink power measurements, the efficiency metric, η can be practically evaluated, in situ, using calibrated Q. In the multi-array transmission case, different v's can correspond to different efficiency in general. In addition, given the bilinear form in both numerator and denominator, η can be independent of any overall scale factor in the beamforming weights, and therefore independent of any overall changes in transmit voltage.

Depending on the beamforming coefficients, a given transmit array loaded with a given subject can operate over a range of efficiencies. Searching for the beamforming weights that maximize η can be accomplished using various numerical optimization procedures. It can be shown that calculating the maximum and minimum of η can be treated as a generalized eigenvalue problem which does not utilize a nonlinear search, and can guarantee the calculation of the global optimum. From the solution obtained with numerical calculations (e.g., the Matlab function eig(γ, Q)), the largest eigenvalue, and its corresponding eigenvector, can represent the maximum transmit efficiency and the maximum efficiency beamforming weights, v, respectively. In this exemplary process, a series of eigenvalues can be used by weighting and combining them to create a diverse transmit pattern. Similarly, an η can be selected to improve battery life of the wireless device by penalizing the denominator of equation 16. Calculated maximum efficiency beamforming weights can be used in real time to obtain the highest possible transmit efficiency for the given array-compliment user configuration. Such exemplary calibration and optimization can be performed in software, and/or in dedicated hardware, such as FPGAs, CPUs, ACIS and other chips.

### Exemplary Direct Beamforming/Channel Selection Using Convex Optimization

The exemplary system, method and computer-accessible medium, according to an exemplary embodiment of the present disclosure, can facilitate pre-calculated strict constraints from compliance measurements and on the fly downlink power measurements for beamforming/channel selection using convex optimization aiming safe/compliant use of mmWave emitting devices. For example:

$${max}_{Y} \text{?} such that \begin{matrix}{Y}^{H} Q \text{?} < definedPowerLimit \\ {v}^{H} Λ ( r ) v < definedSafetyLimit for every r\end{matrix} \\ \text{?} \text{indicates text missing or illegible when filed} \qquad ( 17 )$$

where Γ can be the measured base station power correlation matrix, Q can be the global power correlation matrix, Λ's can be the local power correlation matrices, and defined user safety limits defined by the international bodies such as ICNIRP.

The optimization problem in Eq. 17 can be solved by using a range of efficient strategies for convex optimization, since the power correlation matrices can be positive and definite, and the constraints can be quadratic convex functions. Convex optimization can provide that a global optimum, if it exists, can be found within a defined error bound. The complexity of the optimization problem can increase with the number of elements on the transmit array, and the number of locations, r, that need to be taken care of, can obtained from compliance measurements. A least-squares projection strategy can be used to reduce the complexity of optimization, as a small number of basis vectors can be used to drastically reduce the optimization search space, while maintaining a good approximation to the original problem using, specifically, Lanczos procedure with Gram-Schmidt re-orthogonalization steps. New formulation of the convex optimization problem using 50 reduced-basis vectors can still include the exact power constraints as defined in Eq. 11, and can be solved efficiently using a variety of well-established solvers. This exemplary optimization can be performed in software and/or dedicated hardware such as FPGAs, CPUs, GPUs, ACIS and other processors/chips.

### Exemplary Proximity Sensing Using Q Matrix Calibration

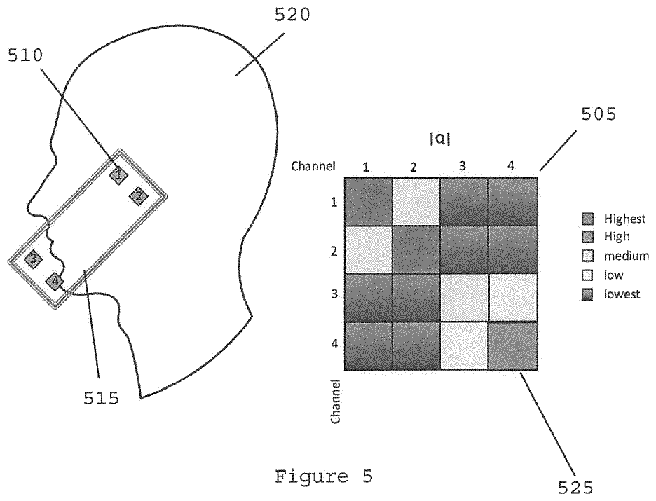

A Q matrix (e.g., element 505 from FIG. 5) can contain information regarding the E field correlation between different antenna elements 510 inside the subject 515. Since this can be calibrated in a subject specific manner, these can indicate the proximity of the antenna array elements to the head 520, and can assist in proper communication while reducing the power deposition inside the head 520. A simple 4 antenna DUT is shown in FIG. 5, where the magnitude of the Q matrix elements 525 are illustrated. Since the elements represent the interaction between the antenna elements inside the body, a proximity detection mechanism can be provided by via simple power measurements and the calibration methodology presented above. The Q matrix 505 can be calibrated periodically such that it properly represents the interaction between the antennas 510 and the body 520. Such exemplary calibration and monitoring can be conducted in software or hardware. A recalibration of the Q matrix 505 can be done if the power prediction can be significantly different from the net power outputted by the device.

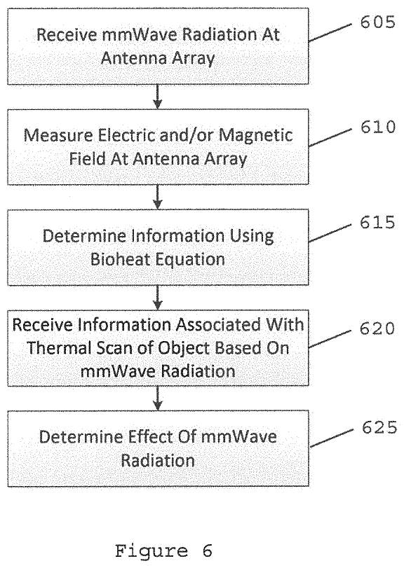

FIG. 6 shows a flow diagram of an exemplary method for determining an effect of a millimeter wave (mmWave) radiation on at least one object according to an exemplary embodiment of the present disclosure. For example, in procedure 605, mmWave radiation can be received at an antenna array, which can be used to measure an electric or a magnetic field at procedure 610. In procedure 615, information about the mmWave radiation can be determined using a bioheat equation, which can be a Pennes' bioheat equation. The information associated with the thermal scan can be received in procedure 620, and the effect of the mmWave radiation can be determined in procedure 625.

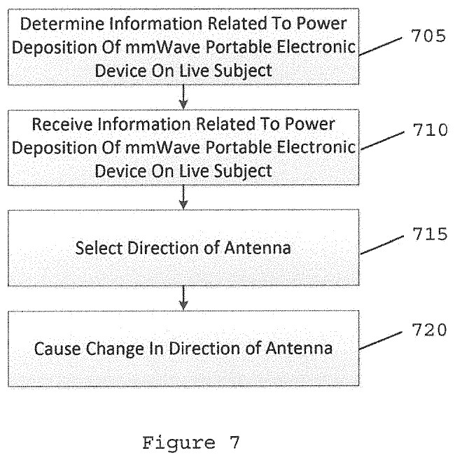

FIG. 7 illustrates a flow diagram of an exemplary method for causing a change in a direction of an antenna of a portable electronic device according to an exemplary embodiment of the present disclosure. For example, in procedure 705, information related to the power deposition of a mmWave portable electronic device on a live subject can be determine, which can be received in procedure 710. In procedure 715. the direction of an antenna can be selected based on the information, ant the direction of the antenna can be changed in procedure 720 based on the selection.

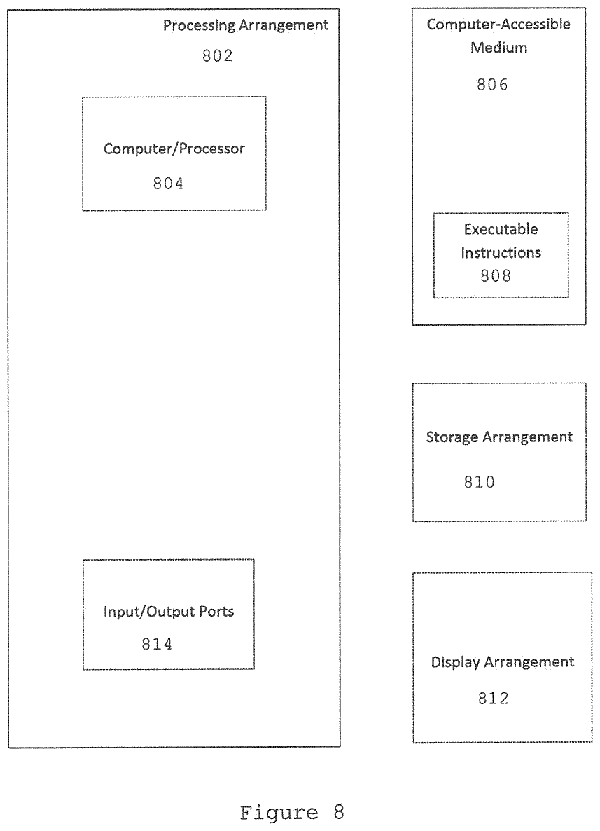

FIG. 8 shows a block diagram of an exemplary embodiment of a system according to the present disclosure. For example, exemplary procedures in accordance with the present disclosure described herein can be performed by a processing arrangement and/or a computing arrangement 802. Such processing/computing arrangement 802 can be, for example entirely or a part of, or include, but not limited to, a computer/processor 804 that can include, for example one or more microprocessors, and use instructions stored on a computer-accessible medium (e.g., RAM, ROM, hard drive, or other storage device).

As shown in FIG. 8 8, for example a computer-accessible medium 806 (e.g., as described herein above, a storage device such as a hard disk, floppy disk, memory stick, CD-ROM, RAM, ROM, etc., or a collection thereof) can be provided (e.g., in communication with the processing arrangement 802). The computer-accessible medium 806 can contain executable instructions 808 thereon. In addition, or alternatively, a storage arrangement 810 can be provided separately from the computer-accessible medium 806, which can provide the instructions to the processing arrangement 802 to configure the processing arrangement to execute certain exemplary procedures, processes and methods, as described herein above, for example.

Further, the exemplary processing arrangement 802 can be provided with or include an input/output arrangement 814, which can include, for example a wired network, a wireless network, the internet, an intranet, a data collection probe, a sensor, etc. As shown in FIG. 8 8, the exemplary processing arrangement 802 can be in communication with an exemplary display arrangement 812, which, according to certain exemplary embodiments of the present disclosure, can be a touch-screen configured for inputting information to the processing arrangement in addition to outputting information from the processing arrangement, for example. Further, the exemplary display 812 and/or a storage arrangement 810 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entirety:

1. Shim D S, Yang C K, Kim J H, Han J P, Cho Y S. Application of Motion Sensors for Beam-Tracking of Mobile Stations in mmWave Communication Systems. Sensors 204; 14(10): 19622-19638.
2. Ghosh A. Can Mmwave Wireless Technology meet the future capacity crunch. Nokia-Siemens Networks: ICC; 2013.
3. Deniz C M, Brown R, Lattanzi R, Alon L, Sodickson D K, Zhu Y. Maximum efficiency radiofrequency shimming: Theory and initial application for hip imaging at 7 tesla. Magnetic resonance in medicine: official journal of the Society of Magnetic Resonance in Medicine/Society of Magnetic Resonance in Medicine 2012.
4. Alon L, Tal A, Deniz C M, Cho G Y, Sodickson D K, Zhu Y. RF Coil Local Power Deposition and Efficiency Evaluation Using a Phantom with High Sensitivity to Temperature Change. 1SMRM2012. p P. 6535.
5. Alon L, Deniz C M, Brown R, Sodickson D K, Zhu Y. Method for in situ characterization of radiofrequency heating in parallel transmit MRI. Magnetic resonance in medicine: official journal of the Society of Magnetic Resonance in Medicine/Society of Magnetic Resonance in Medicine 2013; 69(5): 1457-1465.
6. Deniz C M, Alon L, Cho G Y, Yang X, Collins C., Sodickson D K, Zhu Y. A Novel Method for Experimental Assessment of Antenna Safety Using MR Thermometry. ISMRM2013. p 4424.
7. Cloos M A, Alon L, Chen G., Wiggins G., Sodickson D K. Rapid RF Safety Evaluation for Transmit-Array Coils. ISMRM2013.
8. Alon L., Cho G Y, Sodickson D K., Deniz C M. A Non-Electric (E) Field Based Method for Safety Assessment of RF and Microwave Emitting Devices. Bioelectromagnetics conference 2014: P. 45.
9. Hong W, Baek K H, Lee Y, Kim Y, Ko S T. Study and Prototyping of Practically Large-Scale mmWave Antenna Systems for 5G Cellular Devices. Millimeter-Wave Communications For 5g.
10. Roh W. Performances and Feasibility of mmWave Beamforming Prototype for 5G Cellular Communications. IEEE ICC 2013.
11. Zhadobov M, Chahat N, Sauleau R, Quement C L Drean Y L. Millimeter-wave interactions with the human body: state of knowledge and recent advances. International Journal of Microwave and Wireless Technologies, 2011, 3(2), 237-247. # Cambridge University Press and the European Microwave Association, 2011 dot: 10.1017/S1759078711000122.
12. Sun S, McCartney G R Jr., Samimi M K, Nie S, Rappaport T S. Millimeter Wave Multi-beam Antenna Combining for 5G Cellular Link Improvement in New York City. IEEE ICC 2014—Wireless Communications Symposium.
13. Akdeniz M R, Liu Y, Samimi M K, Sun S, Rangan S, Rappaport T S, Erkip E. Millimeter Wave Channel Modeling and Cellular Capacity Evaluation. arXiv:1312.4921v3 [cs.NI] 25 Apr. 2011.
14. Federal Communication Commission (FCC). Mobile and Portable Devices RF Exposure Procedures. General RF Exposure Guidance. 2013.
15. International Commission on Non-Ionizing Radiation Protection (ICNIRP). Statement on the “Guidelines for limiting exposure to time-varying electric, magnetic, and electromagnetic fields (up to 300 GHz)” 2009 Sep. Report nr 1538-5159 (Electronic) 0017-9078 (Linking). 257-258 p.
16. International Electrotechnical Commission (IEC). 62209-1 Human exposure to radio frequency fields from hand-held and body-mounted wireless communication devices-Human models, instrumentation, and procedures: Part 1. Procedure to determine the specific absorption rate (SAR) for hand-held devices used in close proximity to the ear (frequency range of 300 MHz to 3 GHz). 2005.

1-20. (canceled)

21. A non-transitory computer-accessible medium having stored thereon computer-executable instructions for selecting a utilization of at least one first antenna or at least one second antenna of at least one portable electronic device usable in at least one transmission based on an obstruction due to at least one object, wherein, when a computer hardware arrangement executes the instructions, the computer arrangement is configured to perform procedures comprising:
pulsing the at least one first antenna of the at least one portable electronic device;
determining first information related to a first electric field based on (i) a first forward power produced by the pulsing of the at least one first antenna, and (ii) a first reflected power reflected by the obstruction based on the pulsing of the at least one first antenna;
pulsing the at least one second antenna of the at least one portable electronic device;
determining second information related to a second electric field based on (i) a second forward power produced by the pulsing of the at least one second antenna, and (ii) a second reflected power reflected by the obstruction based on the pulsing of the at least one second antenna;
comparing the first information with the second information; and
selecting the utilization of the at least one first antenna or the at least one second antenna based on the comparison of the first information with the second information.

22. The computer-accessible medium of claim 21, wherein the first information includes a first Q matrix, and the second information includes a second Q matrix.

23. The computer-accessible medium of claim 22, wherein the first Q matrix includes a first Q matrix coefficient and the second Q matrix includes a second Q matrix coefficient, and wherein the computer hardware arrangement is configured to compare the first Q matrix coefficient to the second Q matrix coefficient.

24. The computer-accessible medium of claim 21, wherein the computer hardware arrangement is further configured to determine a specific absorption rate of at least one signal generated by at least one of the at least one first antenna or the at least one second antenna based on the comparison of the first information with the second information.

25. The computer-accessible medium of claim 21, wherein the computer hardware arrangement is further configured to determine a temperature change across the at least one object based on the comparison of the first information with the second information.

26. The computer-accessible medium of claim 21, wherein the computer arrangement is further configured to calibrate at least one of the at least one first antenna or the at least one second antenna based on at least one of (i) a temperature determined based on the comparison of the first information to the second information, (ii) a power density determined based on the comparison of the first information with the second information, or (iii) a specific absorption rate determined based on the comparison of the first information with the second information.

27. The computer-accessible medium of claim 21, wherein the computer-hardware arrangement is further configured to determine the first reflected power and the second reflected power based on an array arrangement that receives the first reflected power and the second reflected power.

28. The computer-accessible medium of claim 27, wherein the array arrangement is a two-dimensional array arrangement that is configured to measure a magnitude of at least one of an electric field or a magnetic field caused by the first reflected power and the second reflected power.

29. The computer-accessible medium of claim 27, wherein the array arrangement includes at least one probe which includes at least one of (i) a plurality of electro-optical (EO) probes, (ii) electric field probes, (iii) magnetic field probes or (iv) thermal probes.

30. The computer-accessible medium of claim 29, wherein the at least one probe is positioned (i) in a two-dimensional plane or (ii) in a vector.

31. A method for selecting a utilization of at least one first antenna or at least one second antenna of at least one portable electronic device usable in at least one transmission based on an obstruction due to at least one object, comprising:
pulsing the at least one first antenna of the at least one portable electronic device;
determining first information related to a first electric field based on (i) a first forward power produced by the pulsing of the at least one first antenna, and (ii) a first reflected power reflected by the obstruction based on the pulsing of the at least one first antenna;
pulsing the at least one second antenna of the at least one portable electronic device;
determining second information related to a second electric field based on (i) a second forward power produced by the pulsing of the at least one second antenna, and (ii) a second reflected power reflected by the obstruction based on the pulsing of the at least one second antenna;
comparing the first information with the second information; and
using a computer arrangement, selecting the utilization of the at least one first antenna or the at least one second antenna based on the comparison of the first information with the second information.

32. A system for selecting a utilization of at least one first antenna or at least one second antenna of at least one portable electronic device to use in at least one transmission based on an obstruction due to at least one object, comprising:
a computer arrangement configured to:
pulse the at least one first antenna of the at least one portable electronic device;
determine first information related to a first electric field based on (i) a first forward power produced by the pulsing of the at least one first antenna, and (ii) a first reflected power reflected by the obstruction based on the pulsing of the at least one first antenna;
pulse the at least one second antenna of the at least one portable electronic device;
determine second information related to a second electric field based on (i) a second forward power produced by the pulsing of the at least one second antenna, and (ii) a second reflected power reflected by the obstruction based on the pulsing of the at least one second antenna;
compare the first information with the second information; and
select the utilization of the at least one first antenna or the at least one second antenna based on the comparison of the first information with the second information.

33. A non-transitory computer-accessible medium having stored thereon computer-executable instructions for causing a change in a direction of at least one antenna in at least one millimeter wave (mmWave) portable electronic device, wherein, when a computer hardware arrangement executes the instructions, the computer arrangement is configured to perform procedures comprising:
determining a forward power produced by pulsing the at least one antenna;
determining a power reflected by at least one live subject based on the pulsing of the at least one antenna;
determining information related to an electric field for the at least one antenna based on the forward power and the reflected power; and
causing the change in the direction based on the information.

34. The computer-accessible medium of claim 33, wherein the portable electronic device is a cell phone.

35. The computer-accessible medium of claim 33, wherein the information includes an electric field correlation matrix.

36. The computer-accessible medium of claim 33, wherein the computer arrangement is further configured to select the direction based on a location of at least one base station configured to wirelessly connect to the at least one mmWave portable electronic device.

37. The computer-accessible medium of claim 33, wherein the computer arrangement is configured to determine the reflected power based on a directional coupler in the at least one mmWave portable electronic device.

38. The computer-accessible medium of claim 33, wherein the computer arrangement causes the change in the direction by adjusting an amplitude and a phase of an antenna array.

39. A method for causing a change in a direction of at least one antenna in at least one millimeter wave (mmWave) portable electronic device, comprising:
determining a forward power produced by pulsing the at least one antenna;
determining a power reflected by at least one live subject based on the pulsing of the at least one antenna;
determining information related to an electric field for the at least one antenna based on the forward power and the reflected power; and
using a computer arrangement, causing the change in the direction based on the information.

40. A system for causing a change in a direction of at least one antenna in at least one millimeter wave (mmWave) portable electronic device, comprising:
a computer arrangement configured to:
determine a forward power produced by pulsing the at least one antenna;
determine a power reflected by at least one live subject based on the pulsing of the at least one antenna;
determine information related to an electric field for the at least one antenna based on the forward power and the reflected power; and
cause the change in the direction based on the information.
